(19) United States
(12) Patent Application Publication
(10) Pub. No.: US 2007/0288603 A1
(43) Pub. Date: Dec. 13, 2007

(54) Receipted transmission of electronic documents over the internet

(76) Inventor: Robert Denzil Onslow, Hampshire (GB)

Correspondence Address: ROBERT ONSLOW, Burnford House, Bramshaw, Hampshire, SO437JB, GB

(21) Appl. No.: 11/761,394

(22) Filed: Jun. 12, 2007

(30) Foreign Application Priority Data
Jun. 12, 2006 (GB) GB0611574.5

(51) Int. Cl. G06F 15/16

(52) U.S. Cl. 709/219

(57) ABSTRACT

A method and apparatus is provided for the transmission and receipt of electronic documents over the internet in which an electronic receipt is returned to the transmitter 1 by the receiver 2 over the connection through which the documents are transmitted by the transmitter 1 to the receiver 2.

This invention relates to a method and apparatus for the receipted transmission of electronic documents over an internet connection.

The following methods currently exist for transmitting a document from a source to a destination: (a) manual carriage of paper documents or electronic storage devices such as CDROMs; (b) facsimile transmissions; (c) email transmissions; (d) connection based transmissions such as FTP. In the case of (a) it is possible to obtain a receipt such as a Court stamp on a copy document evidencing the fact that certain contents of a paper document or electronic storage device has entered the control of the recipient; in case (b) it is possible to obtain a receipt from the transmitting machine evidencing the fact that a transmission of a certain number of pages of a document with unknown content was made to a certain telephone number at a certain time; in case (c) it is possible to obtain a receipt from the recipient acknowledging the fact that an email with certain names of attachments but of uncertain content was received by the recipient server at a certain time on the recipient server's clock, but the receipt is asynchronous with respect to the transmission, and depends on two independent transmission channels operating correctly. There are also usually size restrictions on email attachments. Method (d) is a streaming method which can handle very large documents, returns some limited information over the connection, but the FTP standard positively discourages the return of arbitrary data such as a time stamp and signature data to the transmitter.

This invention provides apparatus for transmitting electronic files from a transmitting computer to a receiving computer comprising, at the transmitter, a marshaller to generate a stream from or based on an in memory object containing references to the electronic file or files to be transmitted, a connection object to form a connection between the transmitter and the receiver over the internet to send the said stream to the receiver and to receive a return stream from the receiver; and a handler to receive the return stream from the connection object and write information from the stream to a persist storage; and at the receiver, at least one handler to stream the said electronic file or files to persistent storage; the receiver having means to return over the said connection data representing the date and/or time of receipt of the electronic file or files and a signature of the electronic file or files.

Preferably, the transmitter part of the apparatus is substantially instructed to operate as such by electronic data received from the receiver.

Preferably also, the transmitter handler or the receiver handler comprise a chain of filters.

More preferably, the return data from the receiver is formed by a transformation of the incoming data by the filters, one such transformation comprising the insertion of the time of receipt data and signature data into the stream, and preferably also the data stream includes XML data.

The invention also provides a method of transmitting electronic file or files over the internet comprising forming in the transmitting computer an in-memory object containing references to the electronic file or files to be transmitted, forming a connection between the transmitting computer and the receiving computer over the internet; generating a stream from or based on the in-memory object, passing the stream through at least one filter in the transmitting computer, the filter operating to inject the electronic file or files to be transmitted into the stream, transmitting the stream over the connection, receiving the stream at the receiver from the connection, passing the stream into at least one handler operating to persist the electronic file or files in the stream, generating return data based on the date and/or time of receipt of the electronic file or files and a signature based on the content of the file or files and returning the date/time data and signature to the transmitter over the said connection.

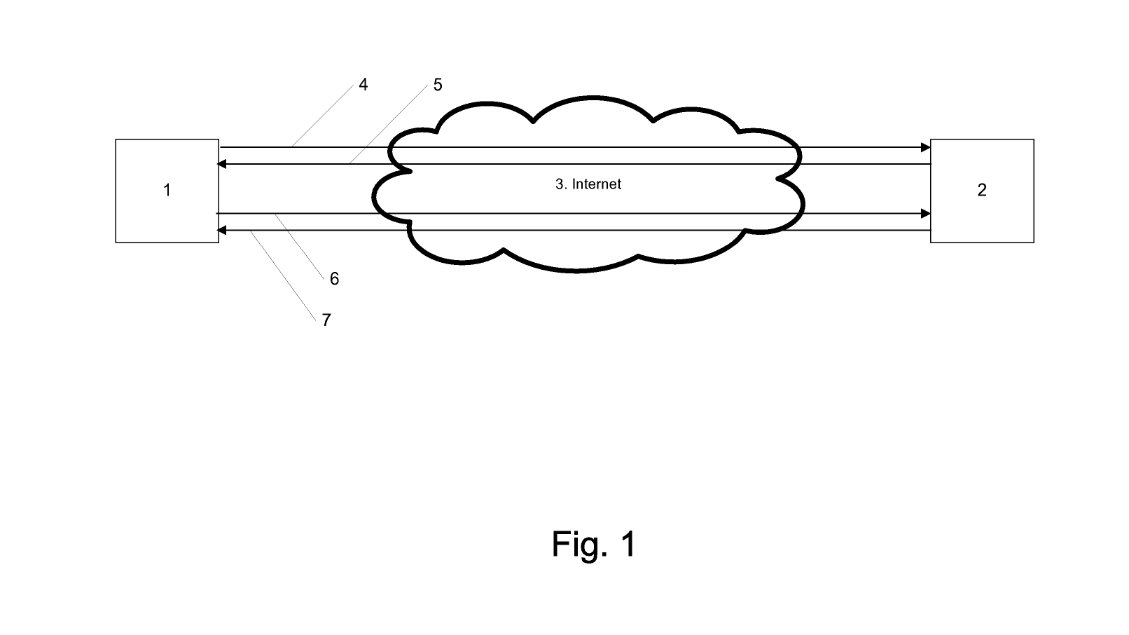

Specific embodiments of the invention will now be described by reference to FIGS. 1 to 7 in which:

FIG. 1 shows a transmitter and received of the invention connected over the internet.

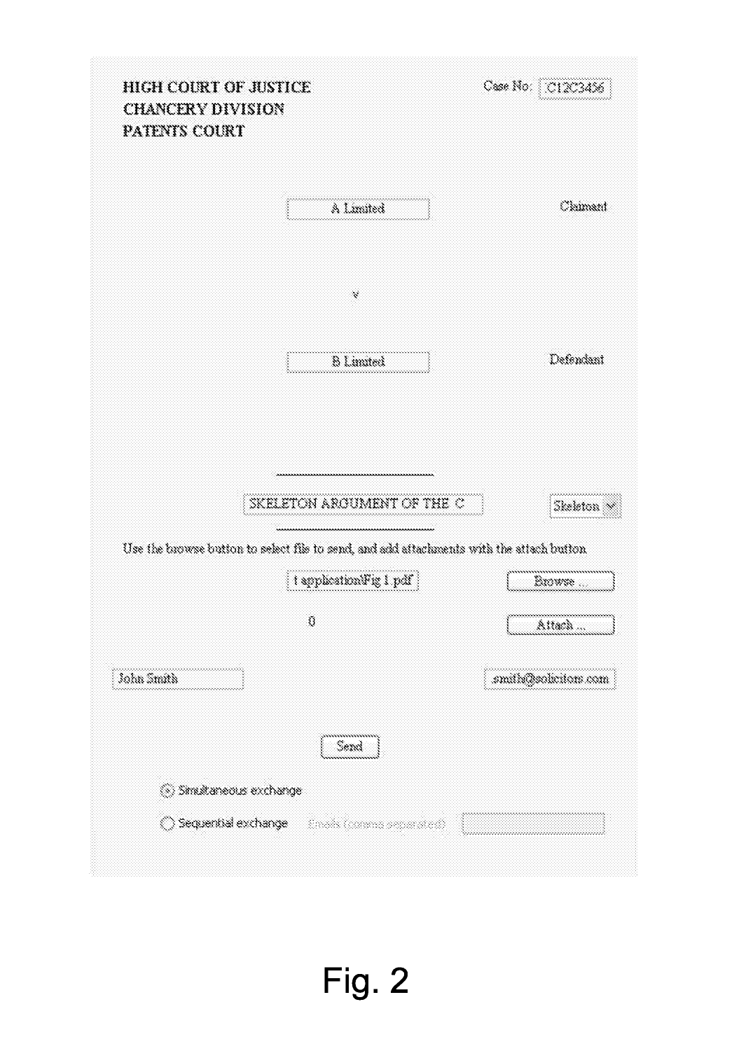

FIG. 2 shows a screen shot of a GUI at the transmitter computer.

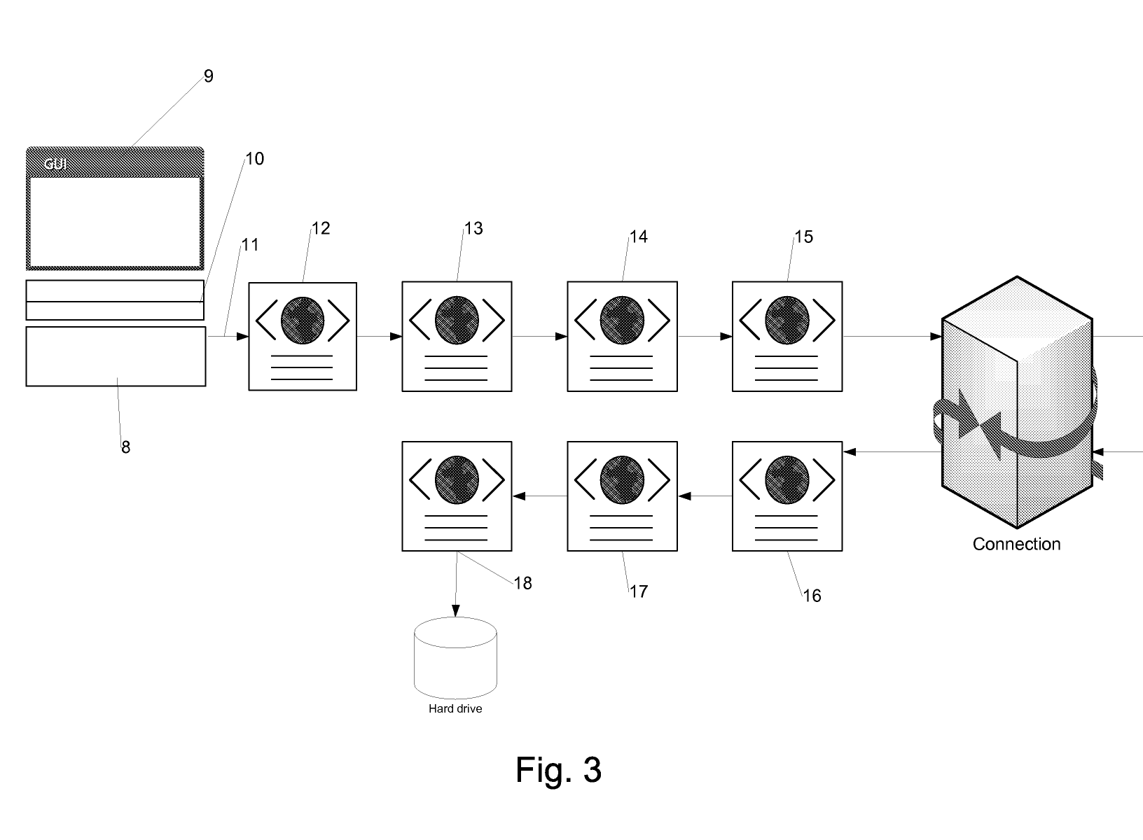

FIG. 3 shows a block diagram of a transmitter.

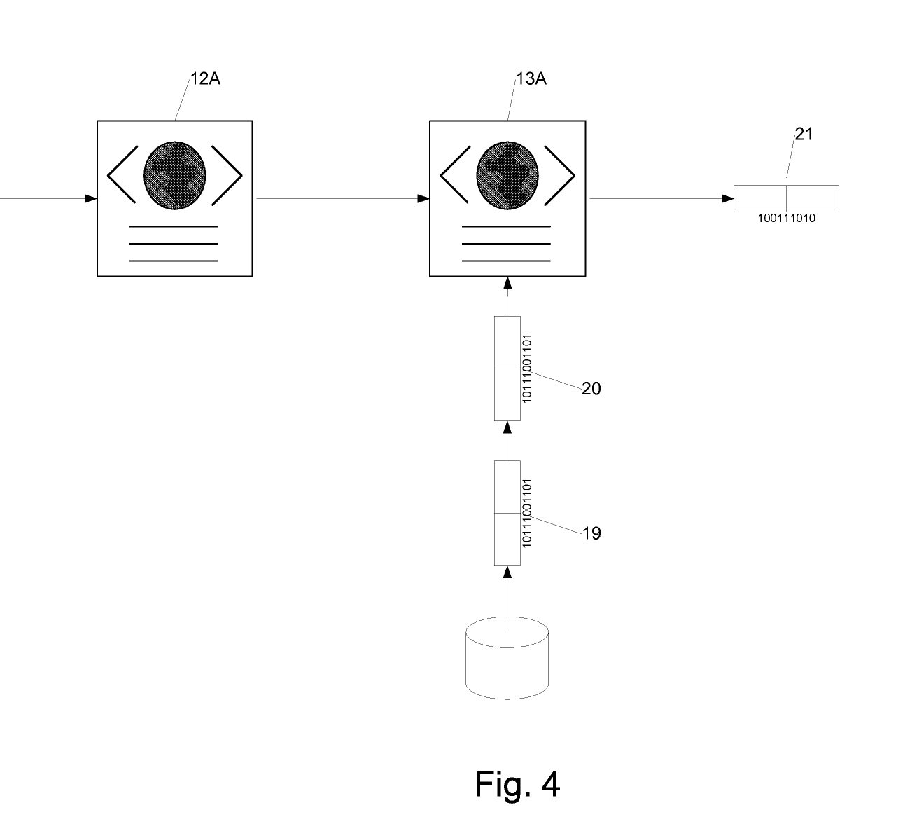

FIG. 4 shows a block diagram of a part of the transmitter in one embodiment.

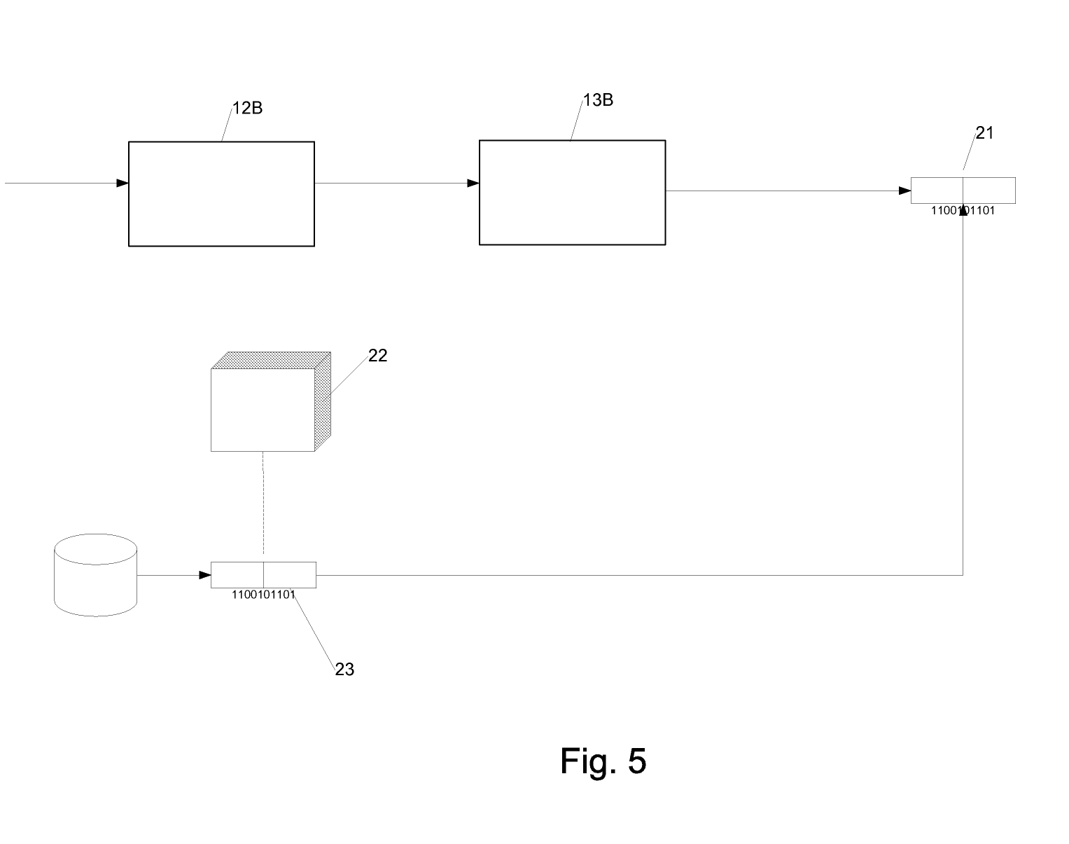

FIG. 5 shows a block diagram of a part of the transmitter in an alternative embodiment.

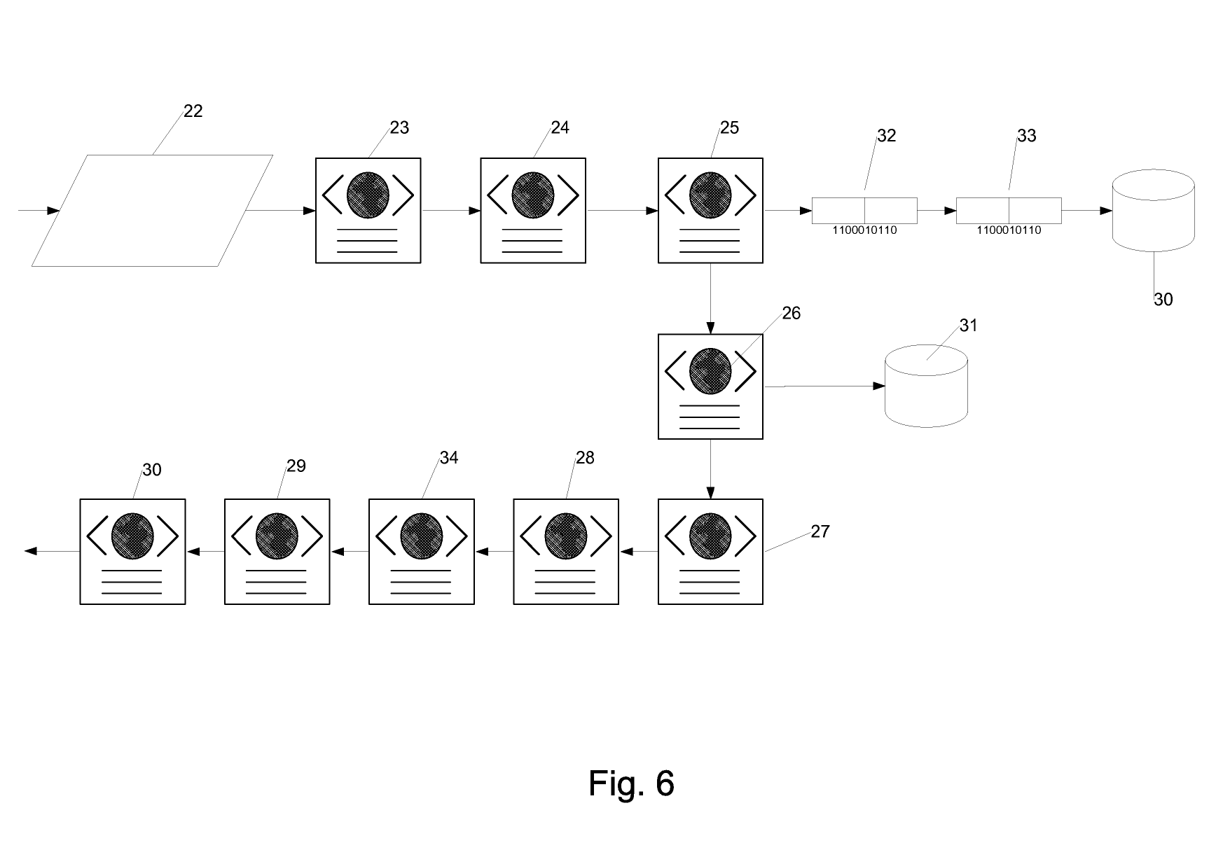

FIG. 6 shows a block diagram of a receiver.

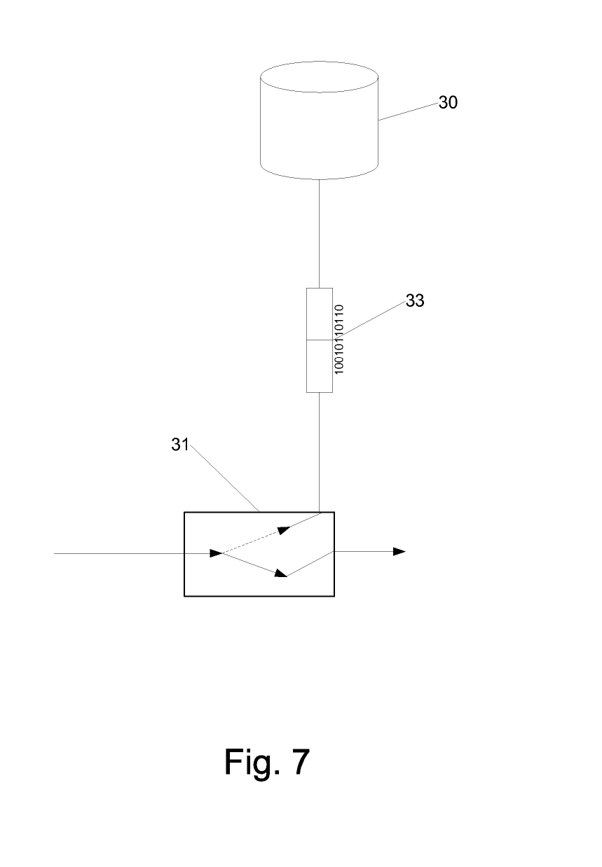

FIG. 7 shows a block diagram of part of the receiver.

With reference to FIG. 1, there is shown a transmitter computer and receiver computer and the internet 3 between the two. In a first phase of one embodiment of the method and apparatus of the invention, the transmitter 1 requests 4 an html page from the receiver 2 over the internet 3, which page contains a signed Java applet. The applet is downloaded 5 to the transmitter 1 in a known fashion, which may include known caching techniques. The applet runs to show a GUI which permits the user at the transmitter 1 to enter data about the document(s) to be transmitted, including the URL of the document(s). In XLegal's XFiling system, which is an embodiment of the present invention, this data entered by the user are a selection of the fields in the LegalXML LegalEnvelope XML wrapper, such as the name of parties to litigation, a case number, some details about the person filing the document, and an object exchange flag (see below). A screen shot of the XFiling applet is shown in FIG. 2. However other embodiments may allow different data to be entered at this stage, for example the Dublin Core extension to the W3 Consortium's RDF protocol, which contains information about the file; BNML which codes for documents with business content and which has extensions for e-contracts; and ebXML which provides wrappers for business to business communication.

Because the applet is transmitted from the receiver 2, it is possible to customise a standard applet to accord with the particular requirements of the recipient organisation, for example by branding or the addition of special fields in the applet. For example, a court may wish to receive LegalXML wrapped documents, whereas a company may wish to receive RDF/Dublin Core wrapped documents. Further, some organisations may wish to impose restrictions on the types of documents which can be filed which other courts may not wish to impose, such as the acceptable MIME types of documents. This can be conveniently done by means of a “policy” class bundled separately from the main applet code i.e. executable objects which, when combined with the main applet code, cause the applet to enforce the restriction. In the XFiling example, a class implementing an interface called CourtPolicy returns a list of file extensions acceptable to the receiver, which is used by the File Open dialog in the applet to limit the view to files with acceptable extensions. In addition, the CourtPolicy implementation returns a regular expression which codes for acceptable forms of case number for that particular court. Further, the receiver 2 can transmit to the transmitter 1 a stylesheet for receipts subsequently received at the transmitter (see below) which will determine how the receipts appear when subsequently opened in a browser, and again are modified to incorporate branding or special data requirements.

In general terms, the applet opens a connection between the transmitter 1 and receiver 2, sends XML data 6 and the electronic file or files, receives confirmation XML data 7 and closes the connection.

The architecture of the transmitter applet is shown in FIG. 3. The data in the form is held in memory in the form of a W3 Consortium DOM object 8 the contents of which are modified by the applet GUI 9, there being provided for convenience an adapter class layer 10 between the GUI 9 and the DOM object 8. The urls of the documents to be filed are entered into the form by means of a selection in a File Dialog box, and are written into the DOM object as strings.

When the user presses the send button, a controlling class layer (not shown) opens a connection with the transmitting computer, and marshals the DOM object into an XML stream 11. In the embodiment, the XML stream is preceded by the SOAP Envelope, SOAP Header and SOAP Body tags, and is followed by a closure of the SOAP Body and SOAP Envelope tags ie the XML is wrapped within the SOAP Body of a SOAP Envelope. The stream passes through a chain of XML filters 12, 13, 14, 15 in the transmitter (XFiling uses derivatives of the standard org.xml.sax.helpers.XMLFilterImpl filters provided with the Java Runtime Environment). Hence the XML “stream” in this example is in the form of SAX events being passed successively through the filters.

The XML Filters described herein are conveniently categorised into two types for the purposes of description: some carry out some function in response to tags within a distinct namespace (“functional XML filters”); others (“transforming XML filters”) are purely transforming, whose purpose is simply to insert the appropriate tags in the appropriate namespaces to control the downstream functional XML filters Preferably the functional filters react to tags in a unique namespace and perform a clearly divisible function which enables extension to the functionality by pluggability of new filters. Further it is desirable that the functional filters remove their activating tags from the XML stream once they have performed their function.

Two variants of the embodiment are now considered. In the first, as shown in FIG. 4 a transforming XML filter 12A listens for the document urls in the outgoing XML stream, which in the case of LegalXML LegalEnvelope, are found on the documentContent element, and substitutes upload tags in a namespace to be recognised by a downstream functional filter 13A, the function of which is to inject the electronic file as Base64 binary data into the XML stream (“upload filter”). The upload filter 13A opens a binary input stream 19 from the file, passing that stream through a binary filter 20 which encodes the stream as Base64 character encoding, and the filter 13A inserts that Base64 character encoding as text content into the XML stream which forms (possibly via other filters) the HTTP transmission stream 21. In this way, the binary data of the file is embedded entirely within the LegalXML envelope. This has the advantage that simpler processing is needed at the receiver end (see below).

The second variant is to use the SOAP with Attachments format of XML transmission. In this variant, shown in FIG. 5, the DOM object is streamed out as before but instead of the transforming filter 12B substituting the url attribute on the documentContent element with upload tags, the attributes containing the url reference are substituted with a SOAP href attribute, which is a reserved attribute in SOAP with Attachments within the SOAP envelope denoting a reference to a forthcoming binary part of a multipart MIME message outside the SOAP envelope. An in-memory mapping object 22 in the transmitter preserves a map of that string reference to the url of the file to be uploaded. Once the DOM object has finished streaming out as the first part of the multipart message, i.e. the SOAP Envelope with LegalXML within the body, the controlling object writes a multipart boundary to the HTTP transmission stream 21 denoting a second part of a multipart message, the string reference is output as the Content-Id header, and the stream 23 from the file to be transmitted is inserted in binary form straight into the outgoing HTTP transmission stream 21. This process is repeated for each attachment for which there is a mapping in the mapping object 22. In this way, there is no need to slow the stream with Base64 encoding/decoding at the transmitter and receiver ends, nor to process large amounts of character data through the chain of XMLFilters at the transmitter end, nor at the receiver end (see below) thus hugely increasing the efficiency of the transmission.

In both cases it will be noted that the uploading process is entirely stream based at the transmitter end. If the lengths of the streams are not pre-known, it is necessary to pass the outgoing stream from the applet through a filter to encode the stream using the “chunked” transport format, setting the corresponding HTTP header Content-Transport-Encoding to “chunked”. An acceptable alternative, which may have speed advantages, is for the transmitter to pre-calculate the length of the streams from file sizes and the size of the DOM object, and to write the Content-Size HTTP header, which means that it is not necessary to use a chunking encoder/decoder at either end. Further and preferably, in the XFiling system, the stream is the subject of a final gzip compression at the transmitter side, setting the Content-Encoding header to “gzip”, the latency in this compressing operation being more than compensated for by the time saving when reducing the stream size for large documents travelling over average internet connections.

Hence although there may be, and should be, some limited buffering of binary data in the transmitter, it will be seen that substantially the data does not reside in the transmitter memory. This distinguishes the system from other methods of generating SOAP with Attachment streams from a client computer, in which both the XML part and the attachment parts are pre-loaded into memory before marshalling into the stream. Thus in the embodiment according to the invention there is no upper limit on the size of document which may be transmitted.

In order to preserve the connection while waiting for the receipt, it has been found that it is desirable to pass the outgoing stream through a binary filter which defers the end of stream indicator (−1 in the case of Java streams) from travelling to the connection object, the effect of which if not deferred may be to cause the connection to close before completion of reading of the receipt, which happens synchronously. This deferring filter is provided with a method which is invoked by the controlling layer only once the connection is ready to be closed ie once the receipt has been received, the effect of which method invocation is to send the end of stream indicator to close the connection in an orderly and expected fashion.

The receiver is, in this embodiment, constructed out of a Java servlet running within the Apache Tomcat servlet container environment. The architecture of this servlet is shown in FIG. 6. The incoming request headers are read, and the incoming stream passed through decompression and dechunking binary filters as necessary. This provides an incoming stream 22 of XML which is passed through a chain of XML filters, again comprising transformation filters and functional filters.

The first XML filter 23 is a transformation filter. In the XFiling embodiment, this filter adds in tags to (a) instruct a downstream filter to place a time based identifier in the messageIdentification element of the LegalEnvelope; (b) place tags around the entire LegalEnvelope which will be used to write the LegalEnvelope to persistent storage; (c) place tags inside the documentContent element to decode, write and sign the Base64 document content to persistent storage; (d) place tags to generate emails to nominated persons signalling the arrival of a document; (e) insert parameter data into the Sender fields of the LegalEnvelope which identifies of the receiver when returning the receipt, (f) inserts tags which are used to invoke a webservice thereby notifying the webservice of the arrival of a document (see below).

Functional XML filters 23, 24. 25, 26, 27, 28 and 29 are then provided in a handler chain to react to the various tags inserted by the first transform filter: the first 24 inserts the time based identifier, the second 25 streams the Base64 character data orthogonally to persistent storage 30 (the persistent storage in the case of XFiling is a WebDAV document repository) via a Base64 decoder binary filter 32, and thereafter through a binary filter 33 which calculates a signature, the signature being reinserted as tags within the XML stream. (In this sense the XML Filter 25 is both functional and transforming i.e. returns a result into the XML stream). Then an XML Filter 26 is provided to copy the XML stream orthogonally to persistent storage 31. This storage 31 is exposed as a webservice to enable other agents, such as a BPEL engine to pick up the XML for subsequent processing (see below).

Next in the chain is an XML filter 27 which notifies a webservice such as a BPEL engine, next an XML filter 28 which emails a predefined email address; next an Object Exchange XML filter 29 which controls the exchange of documents, which is further described below, then a further transformation XML filter 34 which reformats the XML to an appropriate return format such as LegalXML confirmation, and also inserts tags which will generate a time and date stamp within the confirmation receipt; and finally the stream passes through a functional XML filter 30 which adds the time and date stamp within the receipt.

Where the incoming message is SOAP with Attachments, there is no need for a Base64 decoder 32. However a particular problem arises here which is solved in one embodiment of the invention. The signature is necessarily generated from the binary part, which only appears in the stream after the XML part has been completely read and the SOAP Envelope tag has been closed. There is therefore no opportunity to write the signature data into the confirmation receipt while streaming. This is solved, according to one aspect of the invention, by substituting the persistence filter 25 with a switching XML filter, shown in FIG. 7 as 31 which defers i.e. does not pass on the closure of the SOAP Body and SOAP Envelope tags in the XML stream to filters down the chain, but simply reads and discards the incoming stream until it detects the multipart boundary within the stream. Then the filter switches the stream to write to the WebDAV persistence layer 30, via the binary filter 33 which calculates the signature of the stream. After that process has completed, the XML filter 31 fires off tags containing the signature of the documents, then programmatically closes off the SOAP Body and SOAP Envelope tags by calls to the endElement methods of the org.xml.sax.helpers.XMLFilterImpl methods. By using this deferring and switching technique, it is possible to inject tags into a SOAP with Attachments XML stream calculated from data which only appears downstream in subsequent parts of a SOAP with Attachments stream.

In both variants, it is desirable for the XML filter 25, 31 which copies the Base64 or binary data orthogonally to persistent storage to suppress this content data from being passed further down the chain, in order to eliminate unnecessary processing of this data, and to prevent the content being read into memory by an in-memory transformation engine such as Apache Xalan XSLT transformer 34 which is used to perform final formatting of the XML. Although a streaming transformer such as a StaX transformer is an acceptable alternative to be used as the final transformer 34, these tend to be more difficult to use, and require writing fragments of the XML to memory anyway, where the transformation involves shifting later tags to a position earlier in the stream; so that in the case of SOAP with Attachments, where, as described above, the switching XML Filter inevitably places the signature data outside the LegalXML LegalEnvelope content, just before closure of the SOAP Body, but there is typically a requirement to place the signature tags earlier, i.e. within the return LegalEnvelope, this is most easily performed with an in-memory transformer.

Further, in the case of the first variant, it is desirable to place the functional XML filter 26 which copies the XML to persistent storage after, rather than before, the functional XML filter 25 which streams the Base64 data to persistent storage, so that the Base64 character content data is removed before the XML is sent to persistent storage, the Base64 content being substituted with an appropriate url (which may be a relative url) in a suitable attribute, in the case of LegalXML, conveniently on the documentContent element. In this way, the file size of the persisted XML is small, and the XML may be processed by other agents, for example a BPEL engine (see below) without having to process the Base64 content.

Hence it will be seen that at the receiver end, in both the SOAP and SOAP with Attachments protocols, by using these aspects of the invention described above, the binary data are not held in memory, thereby ensuring that there is no upper limit to document size.

Two functional XML filters at the receiver end deserve special mention. The WebService filter 27 invokes a pre-specified webservice when it encounters appropriate tags in its namespace. This can be used to notify a central webservice, such as a BPEL engine, of the arrival of a document. The tags to fire the XML filter 27 are inserted by the first transforming XML Filter 23, the endpoint of the BPEL engine specified within those tags being passed into the transforming filter from servlet parameters provided in the web.xml file for the servlet. The BPEL engine, once notified in this way, can then invoke other webservices within the receiving organisation to process the incoming document. For example in the XFiling embodiment, the BPEL engine retrieves the LegalEnvelope from the XFiling server (as indicated above, the XML in the persistent storage is exposed as a webservice suitable for use by a BPEL engine), and copies it to a clerk's webservice, thereby initiating a workflow to process the filed document. The BPEL engine forms the basis of an extensible service oriented architecture system for document management and case management within an organisation such as a Court, or can be used with webservice adapters to integrate with legacy document management and case management systems.

The second filter to be mentioned here in the context of XFiling is the ObjectExchange filter 34. Tags in the ObjectExchange namespace inserted by the first transformation filter specify the case number, and the email address of the person filing the document. The ObjectExchange filter 34 reacts by calling a pre-specified ObjectExchange webservice, passing those parameters. The ObjectExchange webservice works by detecting whether it has already received notification of a document with that case number, and if so, the ObjectExchange webservice returns to the ObjectExchange filter the email addresses of the individuals who have previously filed under that case number and the urls of their documents. The ObjectExchange filter 34 then sends emails to these email addresses, giving the url of the new document; and sends an email to the person who has just filed the document giving the urls of the previously filed documents. In this way, an automated document exchange mechanism is provided, operating on a simultaneous exchange basis required e.g. for skeleton arguments/court briefs. Alternatively, exchange can be on a “sequential” basis, in which the new document is immediately forwarded by email to recipients named by the sender. Which basis is to be used may be specified in the SOAP header part of the incoming SOAP envelope. Thus in FIG. 2, the radio button options specify the type of exchange to be used, and the appropriate tags are written into the SOAP header which are used by the receiver to fire notification emails as appropriate. Alternatively and preferably, the ObjectExchange webservice may be invoked from the BPEL engine upon notification of the receipt of a document, thereby removing the need for a bespoke XML filter 34, and removing this relatively slow processing step from the XML stream.

The return XML stream is received by the connection object of the transmitter applet. As shown in FIG. 3, this stream is read through handler chain of XML filters 16, 17 and 18 to carry out final processing, before being written to hard drive of the transmitter as a persistent receipt. This architecture is also shown in FIG. 3. The filters are: a transforming filter 16 to add tags in to be processed by downstream XML filters, in particular a tag to insert a date and time stamp based on the transmitter's system clock, and to add a reference to the appropriate stylesheet for viewing the receipt; and a functional XML filter 17 to insert the date and time stamp before the stream is written to persistent storage e.g. a fixed directory under the user's home directory.

The function of the stylesheet will now be explained. Although a receipt from this system of the invention may be in standard form for a variety of organisations e.g. LegalXML for the Courts, nevertheless it will be necessary to alter the presentation of the receipt depending on the identity of the receiving organisation issuing the receipt e.g. by adding branding information or suppressing the display of unnecessary fields. This is achieved by the receiver providing the transmitter with an XSLT stylesheet, which is written to the user's directory preferably upon the applet being started. Once this is done, the stylesheet is available locally to be applied by any XSLT conformant browser when subsequently opening the XML receipt stored on the transmitter. In order to ensure compatibility with non XSLT-compliant browsers, optionally, a final XSLT transformation 18 may be provided to the incoming XML stream which applies the stylesheet so that both the XML and HTML versions of the receipt are written to the hard drive, the XML receipt being authoratitive, the HTML receipt being conveniently viewable.

Although the invention has been described principally by reference to object oriented programming techniques, and Java objects in particular, it will be immediately apparent that the invention can be implemented by other software frameworks, for example the Microsoft NET framework and ActiveX controls are also suitable for transporting executable code from the receiver to the transmitter in a manner analogous to a Java applet. Equally, procedural rather than object oriented architectures may be used.

1. Apparatus for transmitting electronic files from a transmitting computer to a receiving computer comprising, at the transmitter, a marshaller to generate a stream from or based on an in memory object containing references to the electronic file or files to be transmitted, a connection object to form a connection between the transmitter and the receiver over the internet to send the said stream to the receiver and to receive a return stream from the receiver; and a handler to receive the return stream from the connection object and write information from the stream to a persist storage; and at the receiver, at least one handler to stream the said electronic file or files to persistent storage; the receiver having means to return over the said connection data representing the date and/or time of receipt of the electronic file or files and a signature of the electronic file or files.

2. Apparatus according to claim 1 wherein the transmitter part of the apparatus is substantially instructed to operate as such by electronic data received from the receiver.

3. Apparatus according to claim 1 wherein the transmitter handler or the receiver handler comprise a chain of filters.

4. Apparatus according to claim 3 wherein the return data from the receiver is formed by a transformation of the incoming data by the filters, one such transformation comprising the insertion of the time of receipt data and signature data into the stream.

5. Apparatus according to claim 4 wherein the data stream includes XML data.

6. Apparatus according to claim 5 wherein the data stream includes an XML part and at least one binary part, there being provided a filter in the receiver which operates to defer the closure of the XML tags, reads the incoming stream to the part boundary, streams one or more of the binary parts from the incoming stream to persistent storage, inserts tags containing the signature data into the XML stream, and thereafter fires the closure of XML stream.

7. A method of transmitting electronic file or files over the internet comprising forming in the transmitting computer an in-memory object containing references to the electronic file or files to be transmitted, forming a connection between the transmitting computer and the receiving computer over the internet; generating a stream from or based on the in-memory object, passing the stream through at least one filter in the transmitting computer, the filter operating to inject the electronic file or files to be transmitted into the stream, transmitting the stream over the connection, receiving the stream at the receiver from the connection, passing the stream into at least one handler operating to persist the electronic file or files in the stream, generating return data based on the date and/or time of receipt of the electronic file or files and a signature based on the content of the file or files and returning the date/time data and signature to the transmitter over the said connection.

8. A method according to claim 7 wherein the steps are preceded by the step of downloading electronic data from the receiver which causes the transmitter to function in accordance with claim 7.

9. A method according to claim 7 wherein the return data from the receiver is formed by a transformation of the incoming data by the filters, one such transformation comprising the insertion of the date/time data and signature data into the stream.

10. A method according to claim 9 wherein the data includes XML data.

11. A method according to claim 10 wherein the data stream includes an XML part and at least one binary part, the method further comprising suspending the closure of the XML tags, reading to the part boundary, streaming one or more of the binary parts to persistent storage, inserting tags containing the signature data into the XML stream, and thereafter firing the closure of XML stream.
